(19) United States
(12) Patent Application Publication
(10) Pub. No.: US 2017/0132771 A1
(43) Pub. Date: May 11, 2017

(54) SYSTEMS AND METHODS FOR AUTOMATED HIERARCHICAL IMAGE REPRESENTATION AND HAZE REMOVAL

(71) Applicant: BOARD OF REGENTS OF THE UNIVERSITY OF TEXAS SYSTEM, Austin, TX (US)

(72) Inventors: Sos S. Agaian, San Antonio, TX (US); Mehdi Roopaei, San Antonio, TX (US)

(21) Appl. No.: 15/318,668

(22) PCT Filed: Jun. 13, 2015
(86) PCT No.: PCT/US15/35716

§ 371 Date: Dec. 13, 2016

Related U.S. Application Data
(60) Provisional application No. 62/011,642, filed on Jun. 13, 2014.

(51) Int. Cl. G06T 5/40; G06T 5/50; G06T 5/00; G06T 5/20; G06T 7/136; G06T 7/162

(52) U.S. Cl. CPC G06T 5/40; G06T 7/136; G06T 7/162; G06T 5/003; G06T 5/20; G06T 5/50; G06T 2207/10024; G06T 2207/20221; G06T 2207/20076

(57) ABSTRACT

The present invention relates to systems and methods of hierarchical image representation and removal of haze for images, graphics, photographic images, videos, and real-time video. The invented systems/methods may include the configurations and/or steps of: (1) Applying a color space transformation; (2) Computing channels corresponding to the color and content; (3) Decomposing the content channels based on the statistical distribution; (4) Computing image enhancement on decomposed channels; (5) Performing image enhancement algorithms on color channels; (6) Adjusting color parameters; (7) Computing the inverse color transformation to take the image back to the original color space. In embodiments, a method is provided that includes generating a hierarchical representation and segmentation of the image. The disclosed invention has numerous applications including but not limited to digital images, image processing (recognition, de-noising, segmentations, image enhancement), and image system applications (transportation system, medical, thermal, security system, aerospace).

### CROSS-REFERENCE TO RELATED APPLICATIONS

This application claims priority to, and is the National Stage of International Application No. PCT/US15/35716 filed on Jun. 13, 2015 and claims the priority of U.S. Provisional Patent Application Ser. No. 61/011,642, filed on Jun. 13, 2014, the contents of which are incorporated by reference herein in their entirety.

### STATEMENT REGARDING FEDERALLY SPONSORED RESEARCH OR DEVELOPMENT

Not applicable

### FIELD OF THE INVENTION

The present invention generally relates to systems and methods for processing and improving digital images. More specifically, the present invention relates to systems and methods for removing haze from images, improving image quality including color images, generating a hierarchical representation of images, and segmentation generation. This invention also relates to systems and methods for image and video enhancement applications in transportation systems, medical imaging systems, thermal imaging systems, security systems, and aerospace systems.

### BACKGROUND OF THE INVENTION

Without limiting the scope of the disclosed systems and methods, the background is described in connection with a novel system and approach directed to image representation and haze removal.

Imaging in poor atmospheric conditions affects human activities, such as remote sensing and surveillance. Hence, analysis of images taken in haze is important. Moreover, research into atmospheric imaging promotes other domains of vision through scattering media, such as water and tissue. Several computer vision approaches have been proposed to handle scattering environments. In almost every practical scenario in which an image is being captured by a camera, the light reflected from a surface is scattered in the atmosphere before it reaches the camera or other optical devices. This may be due to the presence of aerosols, such as dust, mist, and/or fumes, which deflect light from its original course of propagation. In long distance photography or foggy scenes, this process can have a substantial effect on the image, in which contrasts may be reduced and surface colors may become faint. Such degraded photographs often lack visual colorfulness and appeal, and moreover, they may offer poor visibility of the scene contents. This effect may be an annoyance to amateur, commercial, and/or artistic photographers, as well as undermine the quality of underwater and/or aerial photography. This may also be the case for satellite imaging, which is used for many purposes including, for example, cartography and web mapping, land-use planning, archeology, and/or environmental studies.

There are several approached introduced for de-hazing:

a) Multiple image de-hazing
1) Different degree polarization
2) Different weather condition

b) Single image de-hazing
1) Dark channel estimation,
2) Air-light estimation
3) Transmission and surface shading estimation

A. Multiple image de-hazing: Among current haze removal research, haze estimation methods can be divided into two broad categories of either relying on additional data or using a prior assumption. Methods that rely on additional information include: taking multiple images of the same scene using different degrees of polarization, (such analysis yields an estimate for the distance map of the scene, in addition to a de-hazed image. Example of this approach are given in: Schechner, Y. Y., Narasimhan, S. G., and Nayar, S. K., “Instant de-hazing of images using polarization,” in Proc. IEEE Conf. Computer Vision and Pattern Recognition, 1, 325332 (2001). and Shwartz, S., Namer, E., and Schechner, Y. Y., “Blind haze separation,” in Proc. IEEE Conf. Computer Vision and Pattern Recognition, 1, 1984-1991 (2006)), multiple images taken during different weather conditions, (Nayar, S. and Narasimhan, S., “Vision in bad weather,” in Computer Vision, 1999, the Proceedings of the Seventh IEEE International Conference on, 2, 820-827 vol. 2 (1999)) and methods that require user supplied depth information (Narasimhan, S. G. and Nayar, S. K., “Interactive deweathering of an image using physical models,” in IEEE IEEE Workshop on Color and Photometric Methods in Computer Vision, In Conjunction with ICCV, (October 2003).) or a 3D model (Kopf, J., Neubert, B., Chen, B., Cohen, M., Cohen-Or, D., Deussen, O., Uyttendaele, M., and Lischinski, D., “Deep photo: Model-based photograph enhancement and viewing,” in ACM Transactions on Graphics (Proceedings of SIGGRAPH Asia 2008), 27(5), 116:1-116:10 (2008)) While these approaches may achieve better results of the original image, the extra information required is often not available, and so a more flexible approach is preferable.

B. Single image de-hazing: Significant progress in single image haze removal has been made in recent years. Tan (Tan, R., “Visibility in bad weather from a single image,” in Computer Vision and Pattern Recognition, 2008. CVPR 2008. IEEE Conference on, 1-8 (June 2008)) made the observation that a haze-free image has higher contrast than a hazy image, and was able to obtain results by maximizing contrast in local regions of the input image. However, the final results obtained by this method are not based on a physical model and are often unnatural looking due to over-saturation. Fattal (Fattal, R., “Single image de-hazing,” ACM Transactions on Graphics 27 (August 2008)) was able to obtain results by assuming that transmission and surface shading are locally uncorrelated. With this assumption, he obtains the transmission map through independent component analysis. This is a physically reasonable approach, but this method has trouble with very hazy regions where the different components are difficult to resolve. Lastly, a simple but powerful approach proposed by He et al. (He, K., Sun, J., and Tang, X., “Single image haze removal using dark channel prior,” CVPR, 1956-1963 (2009)) uses dark pixels in local windows to obtain a coarse estimate of the transmission map followed by a refinement step using an image matting technique (Levin, A., Lischinski, D., and Weiss, Y., “A closed-form solution to natural image matting,” IEEE Transactions on Pattern Analysis and Machine Intelligence 30, 228-242 (2008)). Their method obtains results on par with other approaches, and is even applicable with very hazy scenes.

While all of the aforementioned approaches may fulfill their unique purposes, none of them fulfill the need for a practical and effective means for automated hierarchical image representation and haze removal.

The present invention therefore proposes novel systems and methods for automated hierarchical image representation and haze removal.

### BRIEF SUMMARY OF THE INVENTION

The present invention, therefore, provides systems and methods for automated hierarchical image representation and haze removal.

In this invention we provide a new haze removal structure for single image based on image decomposition. There are several image decompositions based on different separating points like as mean (Yeong-Taeg Kim, “Contrast enhancement using brightness preserving bi-histogram equalization”, IEEE Trans. Consumer Electronics, vol. 43, no. 1, pp. 1-8, 1997.) median (Y. Wang, Q. Chen, and B. Zhang, “Image enhancement based on equal area dualistic sub image histogram equalization method”, IEEE Trans. Consumer Electronics, vol. 45, no. 1, pp. 68-75, February 1999) or multiple separating points (S. Chen, and A. R. Ramli, “Minimum mean brightness error bihistogram equalization in contrast enhancement”, IEEE Trans. Consumer Electronics, vol. 49, no. 4, pp. 1310-1319, 2003.

S. Chen, and A. R. Ramli, “Preserving brightness in histogram equalization based contrast enhancement techniques”, Digital Signal Processing, vol. 14, no. 5, pp. 413-428, 2004, K. S. Sim, C. P. Tso, and Y, Y. Tan, “Recursive sub-image histogram equalization applied to gray-scale images,” Pattern Recognition Letters, vol. 28, pp. 1209-1221, 2007, D. Menotti, L. Najman, J. Facon, A. Araujo, “Multi-histogram equalization methods for contrast enhancement and brightness preserving,” IEEE Trans. on Consumer Electronics, vol. 53, no. 3, pp. 1186-1194, 2007, Abdullah-Al-Wadud, M. Kabir, M. Dewan, and O. Chae, “A dynamic histogram equalization for image contrast enhancement”, IEEE Trans. Consumer Electronics, vol. 53, no. 2, pp. 593-600, May 2007 and, H. Ibrahim, N. Kong, “Brightness preserving dynamic histogram equalization for image contrast enhancement”, IEEE Trans. Consumer Electronics, vol. 53, no. 4, pp. 1752-1758, 2007), however in the disclosed invention the image is decomposed based on the cross entropy separating point of histogram. The invention decomposition could be used as a new kind of histogram equalization, or as a part of image enhancement or a de-hazing method/system, or many other applications involving image/video processing.

The innovative systems and methods addresses haze removal for color and gray images and videos. The inherent characteristic of the innovative functions and configurations allow them have superior performances over the existing methods and systems.

Embodiments of the invention provides systems and methods for de-hazing image(s) without relying on a dark channel prior, without using the global atmospheric light estimation, without performing image colors k-means clustering method, without using a polarization-based de-hazing method, and without using multiple images or input of weather conditions. Other embodiments include image quality improvements. In one aspect, a method is provided that includes generating a hierarchical representation of the image. Moreover, the determination of multiyear thresholds algorithm and haze removal systems may be applied to a number of digital images, image processing (recognition, segmentations, image enhancement), and image system applications (transportation system, medical, thermal, security system, aerospace, surveillance, aerial/land/underwater reconnaissance), as well as others.

Certain embodiments of the present invention relate to systems and methods of hierarchical image representation and automated removal of haze for images, graphics, photographic images, videos, and real-time video. The term input or input image may refer to an image, images, or video frames.

Various embodiments of the disclosed systems and methods comprise the steps of: (1) Applying a color space transformation; (2) Computing channels corresponding to the color and content; (3) Decomposing the content channels based on the histogram; (4) Computing image enhancement on decomposed channels; (5) Performing image enhancement algorithms on color channels; (6) Adjusting color parameters; (7) Computing the inverse color transformation to take the image back to the original color space. In one aspect, a method is provided that includes generating a hierarchical representation and segmentation of the image.

Other embodiments include an image processing server and a non-transitory computer-readable storage medium for providing image de-hazing according to the techniques described herein.

The features and advantages described in the specification are not all inclusive and, in particular, many additional features and advantages will be apparent to one of ordinary skill in the art in view of the drawings, specification, and claims. Illustrative examples show the effectiveness in color and gray removal haze in comparison with the existing methods.

### BRIEF DESCRIPTION OF THE SEVERAL VIEWS OF THE DRAWINGS

For a more complete understanding of the features and advantages of the present invention, reference is now made to the detailed description of the invention along with the accompanying figures in which:

FIG. 1 is a flowchart of the color-content image processing of the automated hierarchical image representation and haze removal system in accordance with embodiments of the disclosure;

FIG. 2 is a flow diagram of the image tree graph decomposition (hierarchical representation and segmentation of the image) of the automated hierarchical image representation and haze removal system in accordance with embodiments of the disclosure;

FIG. 3 is a flow diagram of the image haze removal of the automated hierarchical image representation and haze removal system in accordance with embodiments of the disclosure;

FIG. 4 is an image comparison of existing methods against the automated hierarchical image representation and haze removal system in accordance with embodiments of the disclosure;

FIG. 5 is an image comparison of existing methods against the automated hierarchical image representation and haze removal system in accordance with embodiments of the disclosure;

FIG. 6 is a content-information based statistical distribution equalization-block diagram of the automated hierarchical image representation and haze removal system in accordance with embodiments of the disclosure;

FIG. 7 is an image comparison of the content-information based statistical distribution equalization-simulation results of the automated hierarchical image representation and haze removal system in accordance with embodiments of the disclosure;

FIG. 8 is a flow diagram of the automated hierarchical image representation and haze removal system in accordance with embodiments of the disclosure;

FIG. 9 is a flow chart for the automated hierarchical image representation and haze removal system in accordance with embodiments of the disclosure;

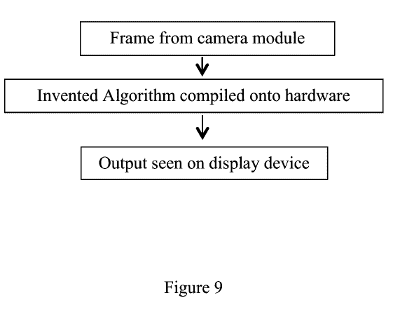

FIG. 10 is a hierarchical image representation of an image of the automated hierarchical image representation and haze removal system in accordance with embodiments of the disclosure;

FIG. 11 is a schematic of fuzzy gray components of the automated hierarchical image representation and haze removal system in accordance with embodiments of the disclosure; and

FIG. 12 is a schematic for fuzzy image decomposition of the automated hierarchical image representation and haze removal system in accordance with embodiments of the disclosure.

### DETAILED DESCRIPTION OF THE INVENTION

Systems and Methods for Fuzzy Hierarchical Image Decomposition

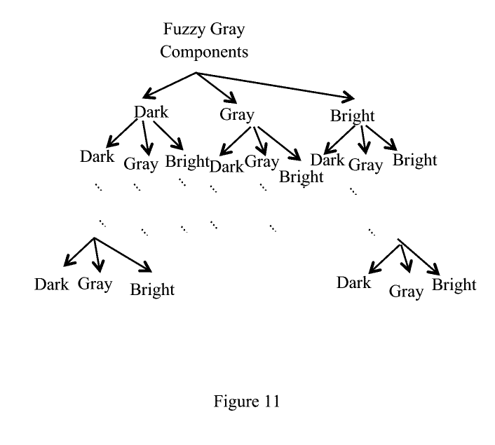

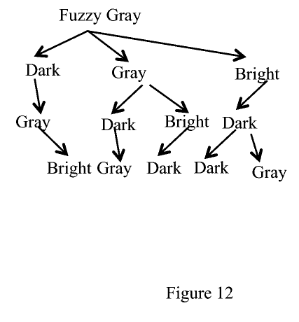

In embodiments of the invention are provided systems and methods for fuzzy hierarchical image decomposition into the set of black and dark components, or, into the set of black, dark, and gray components. The decomposed image can be reconstructed from its set of components. The block diagram of an embodiment of fuzzy gray components into black and dark components, or, into black, dark and gray components is depicted in FIG. 11. Note that for some image decomposition application like as enhancement or segmentation it isn't necessary to use all the components of the tree-structure decomposition, see FIG. 11. Therefore dependent on the image processing application, the number of decomposition layers and the paths in the tree-graph fuzzy decomposition structure should be determined, FIG. 12.

Systems and Methods for Fuzzy Image Segmentation

Another embodiment of the invention provides systems and methods for hierarchical A-Fuzzy Color segmentation. The hierarchical segmentation utilizes an iterative separation value, automatic selection method as a basis to partition an image into two black and dark components. Similarly, every component is segmented into two parts. This process continues until a better segmentation is obtained. Several objective measures are considered to evaluate the quality of segmentation.

The iterative separation value (threshold) selection algorithm can be extended to multilevel separation, is comprised of the following steps.
Step 1: take an image.
Step 2: Decide the desired gray segmentation number G-cut based on complexity of the gray scale as dark and bright components of the image.
Step 3: Decompose the image, I1, and I2, by the iterative separation value selection algorithm in a way that the following condition satisfied:

$$G \text{-} cut = \frac{mean ( {I}_{1} )}{mean ( {I}_{2} )}$$

Step 4: Calculate the second separation value G-cut which will partition two components into two dark and bright components, and calculate the third separation value G-cut which will partition separated components into two new dark and bright components.

Other embodiments of the invention provide systems and methods for hierarchical A-Fuzzy Content segmentation. The hierarchical segmentation utilizes an iterative separation value, automatic selection method as a basis to partition an image into mutual information components. Similarly, every component is segmented into two parts. This process continues until a better segmentation is obtained. Several objective measures are considered to evaluate the quality of segmentation.

The iterative separation value (threshold) selection algorithm can be extended to multilevel separation, is comprised of the following.
Step 1: take an image.
Step 2: Decide the desired gray segmentation number I-cut based on complexity of the mutual information components of the image.
Step 3: Decompose the image, I1, and I2, by the iterative separation value selection algorithm in a way that the following condition satisfied:

I-cut=cross-entropy(I₁, I₂)
I-cut equals to zero, means the minimum cross-entropy between the sub-images.
Step 4: Calculate the second separation value I-cut which will partition two components into two dark and bright components, and calculate the third separation value G-cut which will partition separated components into two new dark and bright components.

Color-Content Image Processing (Enhancement, Recognition, De-Noising, and Others)

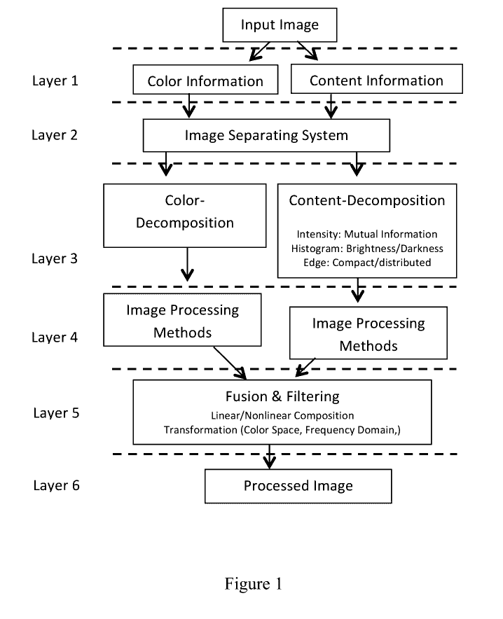

There are several methods for image enhancement. Some of the enhancing methods are based on image decomposition. In these methods a captured image is decomposed based on various features on spatial or frequency domain. As another approach, an image could be decomposed based on the color and content. The content components could contain various knowledge about the image such as: edge, histogram, intensity, and etc. One embodiment of the present invention content-color image enhancement block diagram is depicted in FIG. 1. The description of each layer is described as follows:

Layer 1: In this layer the captured image is decomposed based on the attributes for color and content. There are many features which could be considered for the mentioned decomposition such as but not limited to: edge, intensity, histogram, and etc.

Layer 2: Represent the image based on the features explained in the previous layer, it needs to define a separating system. The existing separating system for example divides the image's histogram based on the mean, median of the intensity. In the current event cross-entropy is selected as the threshold for separating the histogram. However other existing separating points could be used for this layer.

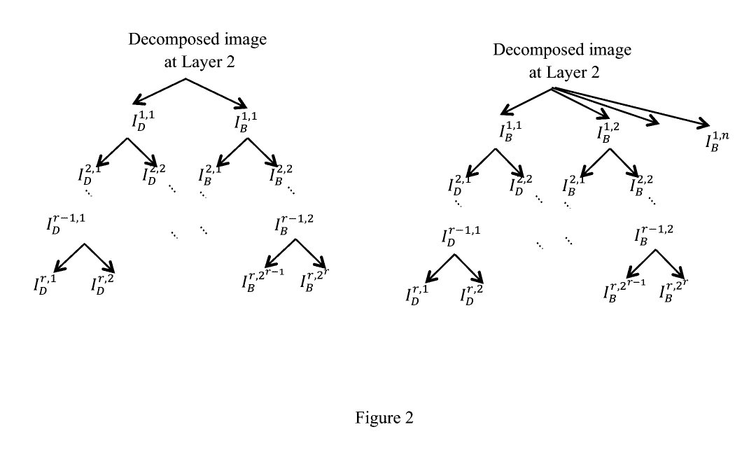

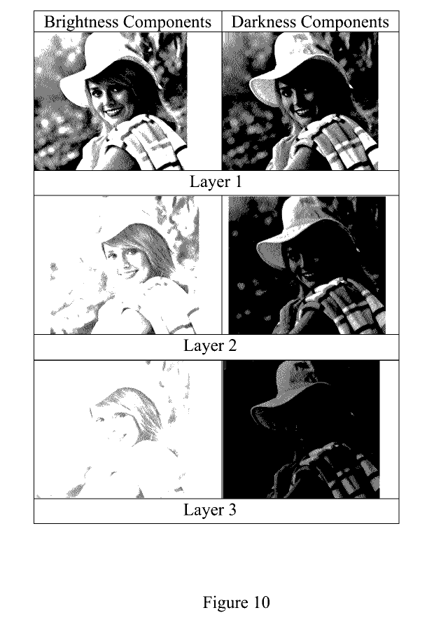

Layer 3: In embodiments, a method is provided that includes generating a hierarchical representation and segmentation of the image. The decomposed images at the previous layers again separated based on a splitting system and practically, generating a hierarchical representation and segmentation of the image. Its created based on a distance between brightness darkness parts of the decomposed images. The decomposition in this layer could be done one time or based on a tree graph hierarchical representation and segmentation of the image as depicted in FIG. 2 and FIG. 10.

Layer 4: Global or local image processing (enhancement, recognition, de-noising, and others) techniques could be applied on the hierarchically decomposed images.

Layer 5: Adjusting color parameters;

Layer 6: The final layer fusing and filtering the decomposed image.

### ILLUSTRATIVE EXAMPLE 1

### Haze Removal

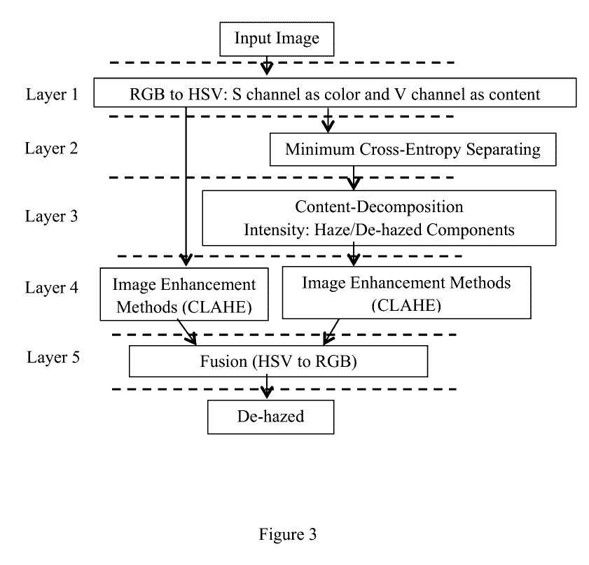

The color-content information image enhancement expressed in this invention can be used as a haze removal technique. The main concept of removing haze in this method is the invented decomposition technique. Utilizing the haze decomposition presented herein, the hazy part of the image is extracted and is removed from the original image. The invented method doesn't need to calculate or estimate the transmission and air/light in the haze model of an image. This disclosed method is a single image haze removal scheme and doesn't have the need to make a 3D model of the image and use multiple images from the image. The key steps of this method are illustrated as FIG. 3, and are comprised of the following steps:
Step 1: Taking an input image
Step 2: Applying a color space transformation and choose the content channels: (for an illustrative simulation the color space transformation is selected RGB to HSV and S channel selected as color information and V chosen as content (intensity))
Step 3: Computing the distance between brightness darkness parts of the decomposed images see for example section. (The description of minimum cross-entropy V channel separating system is defined in the next illustrative example)
Step 4: Decomposing the content channel based on the thresholds created by the distance between brightness darkness parts of the decomposed images. Decomposition is expressed in illustrative example 3. It is a tree-Graph decomposition system which is illustrated in FIG. 2)
Step 5: Applying an image enhancement on content channel, for example applying an image enhancement on V channel.
Step 6: Applying an image enhancement algorithm on color channel, for example S channel.
Step 7: Converting back both content channel and color channel into the original color space by applying the inverse color transformation

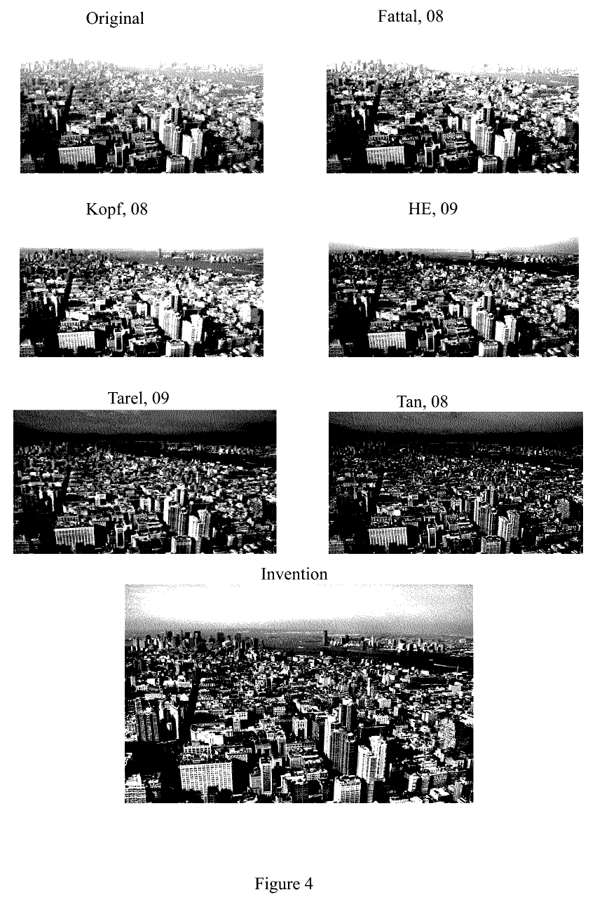

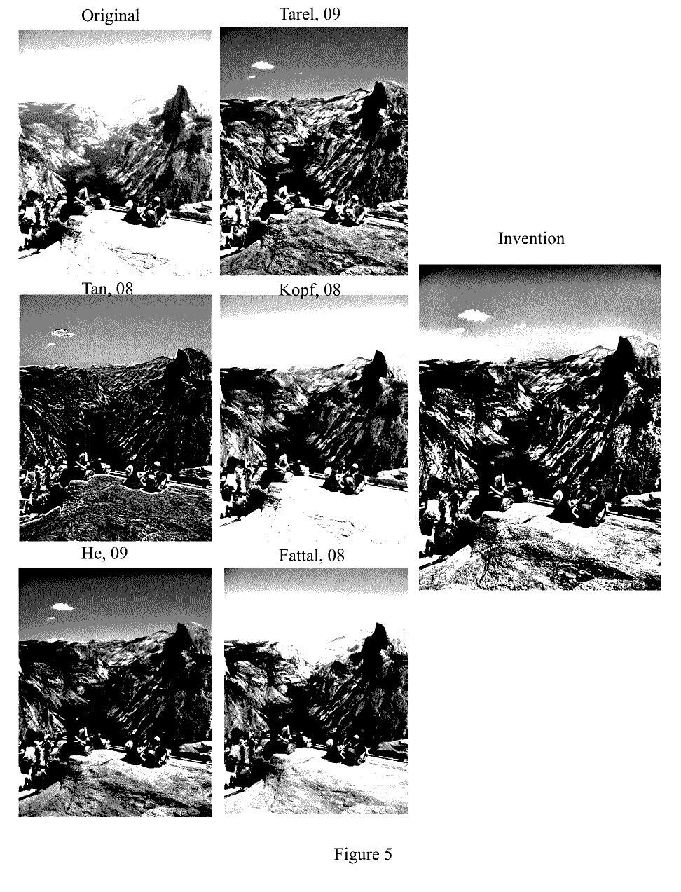

The results of haze removal and comparing with other methods are illustrated in FIGS. 4 and 5. The performance of the invented method to remove the haze produces better results.

### ILLUSTRATIVE EXAMPLE 2

### Hierarchical Representation and Segmentation of the Image or, Brightness/Darkness Cross Entropy Image Separating System

Thresholding is a common and easily implemented form of image segmentation. Many methods of automatic threshold selection based on the optimization of some discriminant function have been proposed. Such functions often take the form of a metric distance or similarity measure between the original image and the segmented result. A non-metric measure, the cross-entropy, is used here to determine the optimum threshold (A. D. Brink, N. E. Pendock, Minimum cross-entropy threshold selection, Pattern Recognition Volume 29, Issue 1, January 1996, Pages 179-188). Among thresholding methods, minimum cross entropy thresholding (MCET) has been widely adopted for its simplicity and the measurement accuracy of the threshold. Although MCET is efficient in the case of bilevel thresholding, it encounters expensive computation when involving multilevel thresholding for exhaustive search on multiple thresholds. An improved scheme based on genetic algorithm is presented for fastening threshold selection in multilevel MCET (Kezong Tanga, Xiaojing Yuanb, Tingkai Suna, Jingyu Yanga, Shang Gao, An improved scheme for minimum cross entropy threshold selection based on genetic algorithm, Knowledge-Based Systems Volume 24, Issue 8, December 2011, Pages 1131-1138).

The MCET has been used for image processing systems but a distinction of the present invention separating system or process is to define based on the new concept of brightness and darkness. In the other words, the separating system applied by this invention attempts to find the distance between the dark and bright part of the image. The description of the present invention cross-entropy separating system is described as follows:

Suppose that an image, I, is divided to Ω block, Ω=k₁×k₂ and it is assumed that the size of the ω^{th} block is k×l. Consider the ω^{th} block where ω=1, . . . , Ω and by sorting the density and intensity values of the mentioned blocks we have:

Pₘᵢₙ≦P₂≦P₃ . . . ≦P_{[T}_{_{k,l}}_{]}≦ . . . ≦Pₘₐₓ Equation 1

Iₘᵢₙ≦I₂≦I₃ . . . ≦I_{[T}_{_{k,l}}_{]}≦ . . . ≦Iₘₐₓ Equation 2

In Iᵢ, i=min . . . max, represent of image intensity values of the blocks being considered and Pᵢ, i=min . . . max, stands for the probability of density value which is defined as: Pⱼ=nⱼ. j is the j^{th} gray level, and nⱼ is the total number of pixels in the image with gray level j. T_{k,l} is the cross-entropy separation point. T_{k,l} is a threshold which is determined based on the minimization of cross entropy between the darkness, P_{D;k,l}^{ω}, and brightness, P_{B;k,l}^{ω}, which are defined as follows:

Brightness Component: P_{B;k,l}^{ω}=Σ_{[T}_{_{k,l}}_{]+1}^{max}Pᵢ/Σₘᵢₙ^{max}Pᵢ Equation 3

Darkness Component: P_{D;k,l}^{ω}=Σₘᵢₙ^{[T}^{_{k,l}}^{]}Pᵢ/Σₘᵢₙ^{max}Pᵢ Equation 4

The distance between brightness and darkness parts of an images is defined as Cross-Entropy between brightness and darkness components:

T_{k,l}=Argminᵢ₌ₘᵢₙ^{max}{P_{D;k,l}^{ω} log P_{D;k,l}^{ω}/P_{B;k,l}^{ω}}

Or,

T_{k,l}=Argminᵢ₌ₘᵢₙ^{max}{P_{B;k,l}^{ω} log P_{B;k,l}^{ω}/P_{D;k,l}^{ω}+P_{D;k,l}^{ω} log P_{D;k,l}^{ω}/P_{B;k,l}^{ω}} Equation 5

We call T_{k,l} as an image brightness darkness separation point or, the cross-entropy separation point.

To calculate the threshold, optimization algorithms could be used such as:
A genetic algorithm, (the algorithm introduced on Kezong Tanga, Xiaojing Yuanb, Tingkai Suna, Jingyu Yanga, Shang Gao, or,
An improved scheme for minimum cross entropy threshold selection based on genetic algorithm, Knowledge-Based Systems Volume 24, Issue 8, December 2011, Pages 1131-1138) recursive algorithms, etc.

An Image Separation method based on the distance between brightness and darkness components is comprised of the steps of:
Step 1: Capturing an input thermal image
Step 2: Applying a color space transformation
Step 3: Taking a color channel of the transformed image
Step 4: Decomposing the image into blocks
Step 5: Sorting the mass values within each block, (2)
Step 6: Defining a threshold value for each block
Step 7: Propose an initial value for threshold and calculate (3) and (4)
Step 8: Applying an optimization algorithm on (5) to find the threshold

### ILLUSTRATIVE EXAMPLE 3

### Content-Information Histogram Equalization, or Cross-Entropy Statistical Distribution Equalization

Other embodiments of the disclosed image enhancement systems can be used as novel histogram equalization methods. Histogram Equalization (HE) is a common non transform-based enhancement which attempts to alter the spatial histogram of an image to closely match a uniform distribution. During past years, various researchers have focused on improving histogram equalization based contrast enhancement techniques. HE is rarely employed in consumer electronic applications such as video surveillance, digital camera, and television since HE tends to introduce some annoying artifacts and unnatural enhancement, including intensity saturation effects. In the other words, HE changes the brightness of an image significantly, therefore saturating the output image with either very bright or dark intensity values. Hence, brightness preservation is an important consideration when using image enhancement for consumer electronic products. In order to overcome the aforementioned problems, brightness preserving histogram equalization based techniques have been proposed. There are several major strategies to preserve the mean brightness of HE-based image enhancement: BBHE (Yeong-Taeg Kim, “Contrast enhancement using brightness preserving bi-histogram equalization”, IEEE Trans. Consumer Electronics, vol. 43, no. 1, pp. 1-8, 1997), initially decomposes an input image into two sub-images based on a separation point equal to the mean intensity of the image. One sub-image is the set of samples less than or equal to the separation point whereas the other sub-image is the set of samples greater than the separation point. Then BBHE equalizes the sub-images independently based on their respective histograms. DSIHE (Y. Wang, Q. Chen, and B. Zhang, “Image enhancement based on equal area dualistic sub image histogram equalization method”, IEEE Trans. Consumer Electronics, vol. 45, no. 1, pp. 68-75, February 1999.), is another algorithm used to preserve the brightness of an image which has a similar procedure as BBHE but the separation point is chosen based on the median of intensity of the captured image. According to the mentioned schemes, two other strategies are introduced but recursively use the same procedure. RMSHE (S. Chen, and A. R. Ramli, “Preserving brightness in histogram equalization based contrast enhancement techniques”, Digital Signal Processing, vol. 14, no. 5, pp. 413-428, 2004), uses BBHE recursively. It first separates the input histogram into two pieces through the mean. Then it applies this step to each piece many times to generate (2n-pieces) histograms. RSIHE (K. S. Sim, C. P. Tso, and Y, Y. Tan, “Recursive sub-image histogram equalization applied to gray-scale images,” Pattern Recognition Letters, vol. 28, pp. 1209-1221, 2007), uses similar tasks with the separation point at the median.

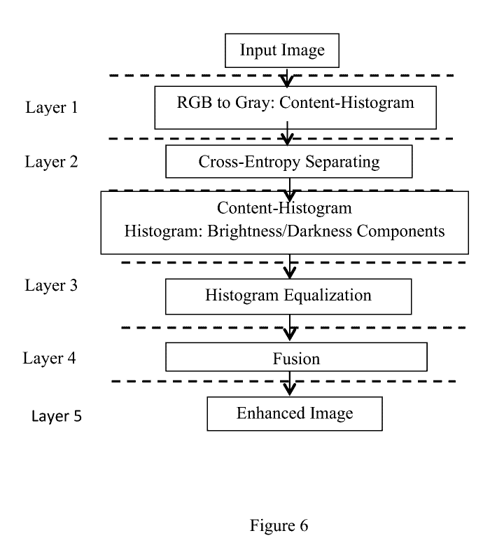

The structure of the new histogram equalization algorithm, called Cross-Entropy Statistical Distribution Equalization, CESDE, is presented in FIG. 6. It based on the
Cross-entropy of the brightness and darkness components of an image and
Attempting to alter the spatial histogram of an image to closely match to a given statistical distribution (for example Beta Distribution, Bivariate Distribution, Cauchy Distribution, Chi Distributions, Exponential Distribution, Extreme Value Distribution, F-Distribution, Fisher's z-Distribution, Gamma Distribution, Logarithmic Distribution, Logistic Distribution, Maxwell Distribution, Normal Distribution, Poisson Distribution, Uniform Distribution).

The disclosed method is based on separating the histogram of the original image into two pieces according to the cross-entropy separation point. Then histogram equalization is applied to each piece. The algorithm of the proposed method is demonstrated as follows.
Step 1: Decompose the image into two images according to a threshold. I=I_{B}+I_{D}. Where I is the input image and I_{B} and I_{D} are the decomposed images.

I_{D}={I(i,j)|I(i,j)≦T,∀(i,j) ∈ I}

I_{B}={I(i,j)|I(i,j)≧T,∀(i,j) ∈ I}
where T is minimum cross-entropy between I_{B} and I_{D}
Step 2: Apply HE on the decomposed images independently:

I_{BH}=HE(I_{B}) and I_{DH}=HE(I_{D}).
Step 3: Fuse the enhanced images, (for example fusion operation could be a linear combination)

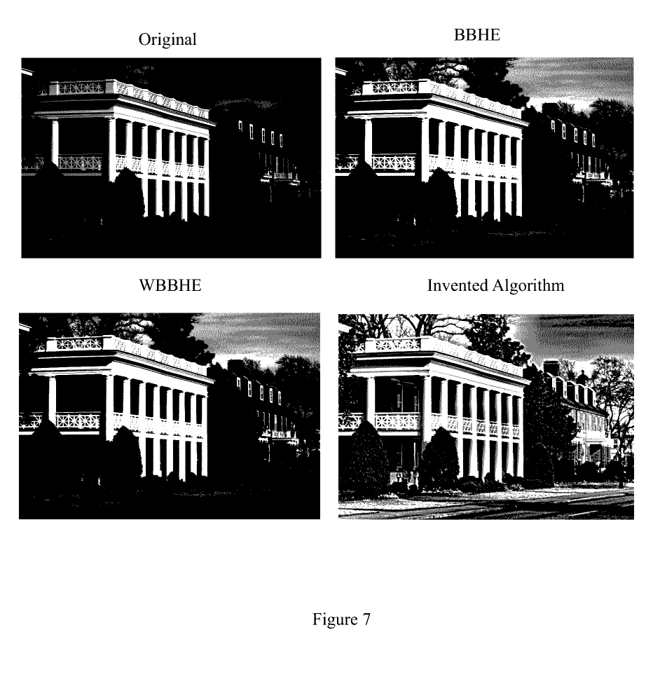

Iₒᵤₜ=αHE(I_{B})+βHE(I_{D})
where α and β are two arbitrary constants. The results of invented content-information histogram equalization are illustrated in FIG. 7.

The weighted values could be defined based on the proposed method by Zongwei, brightness-preserving weighted sub images for contrast enhancement of gray-level images, journal of electronic imaging, 033001-2/033001-11.

In some embodiments a computer or computing device configured to run software or computer instructions may be utilized as an embodiment of the disclosed claimed invention. A computer or computing device in an embodiment may be comprised of at least one processor coupled to a chipset. Also coupled to the chipset are a memory, a storage device, a keyboard, a graphics adapter, a pointing device, and a network adapter. A display is coupled to the graphics adapter. In one embodiment, the functionality of the chipset is provided by a memory controller hub and an I/O controller hub. In another embodiment, the memory is coupled directly to the processor instead of the chipset.

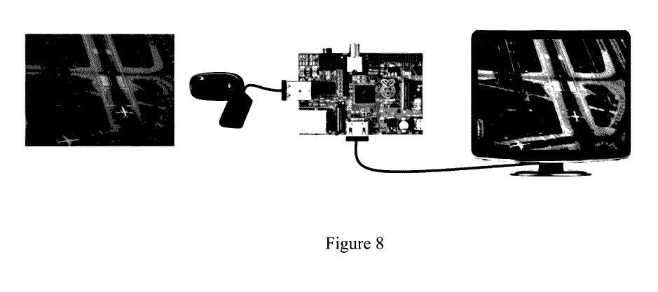

Reference is now made to FIG. 8, a flow diagram of the automated hierarchical image representation and haze removal system in accordance with embodiments of the disclosure. From the left side we have an input image which is received by the hierarchical image representation and haze removal system. In embodiments, the system receives from an external source, the image used for processing. In other embodiments, the system is comprised of an image capturing device such as but not limited to a USB camera, built in laptop camera, camera module, built in phone/tablet camera, or a general purpose camera. The main component of the system in embodiments is a computing device configured to perform the steps discussed herein for hierarchical image representation and haze removal. In embodiments, this may include some of the following components: a desktop, laptio, “Raspberry Pi”, BeagleBone Black, ODROID, Android tablet, Android phone, Linux or Windows OS. As illustrated in this figure, the output is a user interface or display. In an embodiment the display is a display with input video connections.

The storage device is any non-transitory computer-readable storage medium, such as a hard drive, compact disk read-only memory (CD-ROM), DVD, or a solid-state memory device. The memory holds instructions and data used by the processor. The pointing device may be a mouse, track ball, or other type of pointing device, and is used in combination with the keyboard to input data into the computer system. The graphics adapter displays images and other information on the display. The network adapter couples the computer system to a local or wide area network.

As is known in the art, a computer can have different and/or other components than those described above. In addition, the computer can lack certain components described above. In one embodiment, a computer acting as an image processing server lacks a keyboard, pointing device, graphics adapter, and/or display. Moreover, the storage device can be local and/or remote from the computer (such as embodied within a storage area network (SAN)). As is known in the art, the computer is adapted to execute computer program modules for providing functionality previously described herein. In one embodiment, program modules are stored on the storage device, loaded into the memory, and executed by the processor.

Some embodiments of the invention include an image-processing device. The image processing device may include an input unit for receiving a black and white image or a color image, a memory unit for storing application programs for processing the images input through the input unit, and an image processing unit for hierarchical image representation and automated removal of haze image through the input unit and producing an improved output image.

The disclosure herein has been described in particular detail with respect certain embodiments. Those of skill in the art will appreciate that other embodiments may be practiced. First, the particular naming of the components and variables, capitalization of terms, the attributes, data structures, or any other programming or structural aspect is not mandatory or significant, and the mechanisms that implement the invention or its features may have different names, formats, or protocols. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented configurations and may be achieved by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or the like, refer to the action and processes of a computer system, or similar electronic computing device, that manipulates and transforms data represented as physical (electronic) quantities within the computer system memories or registers or other such information storage, transmission or display devices.

Certain aspects of the embodiments disclosed herein include process steps and instructions described herein in the form of an algorithm. It should be noted that the process steps and instructions could be embodied in software, firmware or hardware, and when embodied in software, could be downloaded to reside on and be operated from different platforms used by real time network operating systems.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, the present invention is not described with reference to any particular programming language. It is appreciated that a variety of programming languages may be used to implement the teachings of the present invention as described herein, and any references to specific languages are provided for enablement and best mode of the present invention.

The embodiments disclosed herein are well suited to a wide variety of computer network systems over numerous topologies. Within this field, the configuration and management of large networks comprise storage devices and computers that are communicatively coupled to dissimilar computers and storage devices over a network, such as the Internet.

The disclosed systems and methods are generally described, with examples incorporated as particular embodiments of the invention and to demonstrate the practice and advantages thereof. It is understood that the examples are given by way of illustration and are not intended to limit the specification or the claims in any manner.

To facilitate the understanding of this invention, a number of terms may be defined below. Terms defined herein have meanings as commonly understood by a person of ordinary skill in the areas relevant to the present invention.

Terms such as “a”, “an”, and “the” are not intended to refer to only a singular entity, but include the general class of which a specific example may be used for illustration. The terminology herein is used to describe specific embodiments of the invention, but their usage does not delimit the disclosed device or method, except as may be outlined in the claims. Alternative applications of the disclosed system and method of use are directed to resource management of physical and data systems. Consequently, any embodiments comprising a one component or a multi-component system having the structures as herein disclosed with similar function shall fall into the coverage of claims of the present invention and shall lack the novelty and inventive step criteria.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific systems and methods of use described herein. Such equivalents are considered to be within the scope of this invention and are covered by the claims.

All publications, references, patents, and patent applications mentioned in the specification are indicative of the level of those skilled in the art to which this invention pertains. All publications, references, patents, and patent application are herein incorporated by reference to the same extent as if each individual publication, reference, patent, or patent application was specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of” respectively, shall be closed or semi-closed transitional phrases. The systems and/or methods disclosed and claimed herein can be made and executed without undue experimentation in light of the present disclosure. While the systems and methods of this invention have been described in terms of preferred embodiments, it will be apparent to those skilled in the art that variations may be applied to the system and/or methods and in the steps or in the sequence of steps of the method described herein without departing from the concept, spirit, and scope of the invention.

More specifically, it will be apparent that certain components, which are both shape and material related, may be substituted for the components described herein while the same or similar results would be achieved. All such similar substitutes and modifications apparent to those skilled in the art are deemed to be within the spirit, scope, and concept of the invention as defined by the appended claims.

What is claimed is:

1. A computer-implemented method for image and video enhancement, comprising the steps of:
a. decomposing, with a processor, an input into several images based on color and content information;
b. computing a model of multiyear thresholds;
c. constituting the decomposed input into several components based on computed said multiyear thresholds;
d. decompose the extracted feature of color or content based on the input components;
e. applying suitable input enhancement processes for color and/or content; and
f. fusing and filtering the input components and generating the de-haze/enhanced input.

2. The method of claim 1, wherein said input is at least one image.

3. The method of claim 1, wherein said input is video.

4. The method of claim 1, wherein color and content information is calculated based on image information from the group consisting of edge, intensity, or histogram.

5. The method of claim 1, wherein the features for color and content information is a color space transformation such as RGB to HSV, wherein H and S channels contain color information and V contains content information.

6. The method of claim 1, wherein said multiyear thresholds are achieved by using the distance between darkness and brightness of an input.

7. The method of claim 6, wherein the distance between said darkness and brightness of an input can be computed by using minimum/maximum cross entropy between color and/or content information.

8. The method of claim 1, wherein said decomposed components could be achieved in one step or the decomposition could be iterated until reaching a defined level.

9. The method of claim 1, wherein the computer-implemented method for image enhancement is local or global.

10. The method of claim 1, wherein the computer-implemented method for image enhancement is in the spatial or frequency domain.

11. The method of claim 1, wherein the image fusion and filtering steps is from the group type of local, global linear, and global nonlinear.

12. A computer implemented method for haze removal in images and video, comprising the steps of:
a. applying, with a processor, a color space transform to an input;
b. computing channels corresponding to the color and content;
c. decomposing the content channels based on the histogram;
d. computing image enhancement on decomposed content channels;
e. performing image enhancement algorithms on color channels;
f. adjusting color parameter;
g. computing the inverse color transformation to take the input back to the original color space.

13. The method of claim 12, wherein said input is at least one image.

14. The method of claim 12, wherein said input is video.

15. The method of claim 12, wherein said color space transform contains content and color information.

16. The method of claim 12, wherein said method uses all color and content channels.

17. The method of claim 12, wherein said method uses only some of the color and content channels.

18. The method of claim 12, wherein the histogram decomposition of content channel is performed based on the minimum cross entropy threshold.

19. The method of claim 12, wherein said histogram decomposition of content channel is performed based on a separating point.

20. The method of claim 12, wherein said decomposed input based on the histogram are defined as haze and de-haze components.

21. A computer implemented method for content-information histogram equalization for image measurements, comprising the steps of:
a. applying, with a processor, a color space transformation to an input and choosing the content channels;
b. applying minimum cross-entropy separating systems;
c. decomposing the images based on thresholds;
d. applying histogram equalization on decomposed images;
e. fusing all the decomposed components and making the enhanced image.

22. The method of claim 21, wherein said input image is a color or gray scale image.

23. The method of claim 21, wherein said color space transformation is RGB to gray.

24. The method of claim 21, wherein said color space transformation is RGB to HSV.

25. The method of claim 21, wherein said separating system is a minimum cross-entropy system further comprising an entropy definition of an image;

26. A computer implemented method for cross-entropy separating system for image decomposition, comprising:
a. capturing a gray scale input image;
b. sorting the probability density value of the image's histogram;
c. assigning a threshold based on the minimum cross-entropy of brightness and darkness-component of histogram;
d. capturing an initial value for the threshold;
e. Applying an optimization algorithm to find the minimum value of brightness/darkness cross-entropy.

27. The method of claim 26, wherein said brightness/darkness minimum cross-entropy includes an entropy definition of an image.

28. The method of claim 26, wherein the minimum cross-entropy is based on said histogram.

29. The method of claim 26, wherein the minimum cross-entropy is based on a combination of said histogram and the intensity of said image.

30. The method of claim 26, wherein said image is decomposed into three sub-images based on the interval below the minimum cross-entropy of brightness and darkness and between the minimum and maximum.

31. A computer system for image and video enhancement, the system comprising:
a. a computer processor; and
b. a non-transitory computer-readable storage medium storing executable instructions configured to execute on the computer processor, the instructions when executed by the computer processor are configured to perform steps comprising:
1. decomposing, with a processor, an input into several images based on color and content information;
2. computing a model of multiyear thresholds;
3. constituting the decomposed input into several components based on computed said multiyear thresholds;
4. decompose the extracted feature of color or content based on the input components;
5. applying suitable input enhancement processes for color and/or content; and
6. fusing and filtering the input components and generating the de-haze/enhanced input.

32. A system for haze removal in images and video, the system comprising:
a. a computer processor; and
b. a non-transitory computer-readable storage medium storing executable instructions configured to execute on the computer processor, the instructions when executed by the computer processor are configured to perform steps comprising:
1. applying a color space transform to an input;
2. computing channels corresponding to the color and content;
3. decomposing the content channels based on the histogram;
4. computing image enhancement on decomposed content channels;
5. performing image enhancement algorithms on color channels;
6. adjusting color parameter;
7. computing the inverse color transformation to take the input back to the original color space.

33. A system for content-information histogram equalization for image measurements, the system comprising:
a. a computer processor; and
b. a non-transitory computer-readable storage medium storing executable instructions configured to execute on the computer processor, the instructions when executed by the computer processor are configured to perform steps comprising:
1. applying, with a processor, a color space transformation to an input and choosing the content channels;
2. applying minimum cross-entropy separating systems;
3. decomposing the images based on thresholds;
4. applying histogram equalization on decomposed images;
5. fusing all the decomposed components and making the enhanced image.

34. A system for cross-entropy separating system for image decomposition, the system comprising:
a. a computer processor; and
b. a non-transitory computer-readable storage medium storing executable instructions configured to execute on the computer processor, the instructions when executed by the computer processor are configured to perform steps comprising:
1. capturing a gray scale input image;
2. sorting the probability density value of the image's histogram;
3. assigning a threshold based on the minimum cross-entropy of brightness and darkness-component of histogram;
4. capturing an initial value for the threshold;
5. applying an optimization algorithm to find the minimum value of brightness/darkness cross-entropy.
